(19) United States
(12) Patent Application Publication
(10) Pub. No.: US 2020/0239501 A1
(43) Pub. Date: Jul. 30, 2020

(54) PHOSPHOROUS CONTAINING ANTIWEAR ADDITIVES

(71) Applicant: The Lubrizol Corporation, Wickliffe, OH (US)

(72) Inventors: William R.S. Barton, Belper, Derby (GB); Paul E. Adams, Willoughby, OH (US); Daniel J. Saccomando, Sheffield (GB); Jamal Kassir, Dearborn, MI (US)

(21) Appl. No.: 16/652,289

(22) PCT Filed: Oct. 1, 2018
(86) PCT No.: PCT/US2018/053697

§ 371 Date: Mar. 30, 2020

Related U.S. Application Data
(60) Provisional application No. 62/566,830, filed on Oct. 2, 2017.

(51) Int. Cl. C07F 9/09; C07F 9/6571; C10M 137/08

(52) U.S. Cl. CPC C07F 9/091; C10N 2250/10; C07F 9/6571; C10M 137/08; C10M 2209/084; C10M 2205/0285; C10M 2215/28; C10M 2219/022; C10M 2223/043; C10N 2230/06; C10N 2240/04; C10N 2240/10; C10N 2240/12; C10N 2240/30; C10N 2240/40; C07F 9/093

(57) ABSTRACT

A process is provided for preparing a salt of a hydroxy-substituted di-ester of phosphoric acid, comprising: (a) reacting a phosphating agent with a monohydric alcohol and with a propylene glycol, wherein the mole ratio of monohydric alcohol : propylene glycol is greater than about 4:1 and wherein an excess of the phosphating agent is employed such that the product mixture formed thereby contains phosphorus acid functionality; and (b) reacting the product mixture of step (a) with an amine. The product is useful as an antiwear agent.

### FIELD OF THE INVENTION

The disclosed technology relates to an antiwear agent and lubricating compositions thereof, and an improved method for preparing the antiwear agent. The invention further provides for a method of lubricating a driveline device or a grease application by employing a lubricating composition containing the antiwear agent. The lubricating compositions are also useful in engine oils, industrial lubrication and metalworking applications.

### BACKGROUND OF THE INVENTION

Driveline power transmitting devices (such as gears or transmissions, especially axle fluids and manual transmission fluids (MTFs)) and grease applications, present highly challenging technological problems and solutions for satisfying the multiple and often conflicting lubricating requirements, while providing durability and cleanliness.

The development of new antiwear chemistry for such applications as gear oils has been driven by the desire to provide chemistries that meet modern lubricating requirements, provide thermo-oxidative stability and cleanliness, and have non-objectionable odor. Many current phosphorus antiwear or extreme pressure additives contain sulfur. Due to increasing environmental concerns, the presence of sulfur in antiwear or extreme pressure additives is becoming less desirable. In addition, many of the sulfur-containing antiwear or extreme pressure additives evolve volatile sulfur species, resulting in lubricating compositions containing antiwear or extreme pressure additives having an odor, which may also be detrimental to the environment or evolve emissions that may be higher than increasingly tighter health and safety legislation specifies.

Further, performance requirements of antiwear or extreme pressure additives can depend on gear configuration. For example, some light duty hypoid gears have changed from a ring to pin ratio of 5.86 to 1 to 4.45 to 1. Due to these changes the ring to pin ratios, some previously effective antiwear or extreme pressure additives have failed AS™ D6121 STANDARD TEST METHOD FOR EVALUATION OF THE LOAD CARRYING CAPACITY OF LUBRICANTS UNDER CONDITIONS OF LOW SPEED AND HIGH TORQUE USED FOR FINAL HYPOID DRIVE AXLES.

### SUMMARY OF THE INVENTION

It was surprisingly found that under the AS™ D6121, the performance of salts of hydroxy-substituted (di)esters of phosphoric acid (“phosphate salts”) varied with the type and amount of alkylene polyol used to prepare the salts. In particular, phosphate salts made with low levels of propylene glycol performed surprisingly better that phosphate salts made with other types of alkylene polyols, and even better than phosphate salts made with high levels of propylene glycol. Accordingly, the disclosed technology provides a process for preparing a salt of a hydroxy-substituted (di)ester of phosphoric acid, comprising: (a) reacting a phosphating agent with a monohydric alcohol and with propylene glycol, wherein the mole ratio of monohydric alcohol:propylene glycol is greater than about 4:1, whereby the product mixture formed thereby contains phosphorus acid functionality (that is, not all the P—OH groups are esterified); and (b) reacting the product mixture of step (a) with an amine. In one embodiment the amine comprises at least one alkyl primary amine or at least one alkyl secondary amine. In one embodiment, an excess of the phosphating agent may be employed.

The disclosed technology also provides the use of the above process to prepare an antiwear agent.

The disclosed technology also provides the product prepared by the above-mentioned process, and a lubricant comprising an oil of lubricating viscosity and the product so prepared. The technology also provides a method for lubricating a gear, an axle, or a transmission, comprising supplying thereto such a lubricant.

The disclosed technology also provides a composition comprising an alkyl primary amine salt or an alkyl secondary amine salt of a phosphorus-containing composition which comprises at least some molecules represented by the formulas

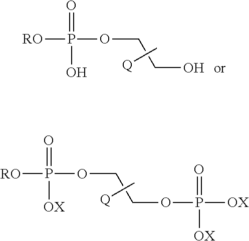

where R is an alkyl group having 4 to 20 carbon atoms, each Q is methyl, and each X is independently R, or H, or a —R′OH group where R′ is derived from propylene glycol, provided that at least one X is H, further provided that said composition is substantially free from species containing a dimeric or oligomeric moiety derived from the dimerization of oligomerization of an alkylene oxide.

The disclosed technology also provides the use of the produce as described herein to impart antiwear performance to a lubricant composition.

### DETAILED DESCRIPTION OF THE INVENTION

Various preferred features and embodiments will be described below by way of non-limiting illustration.

The disclosed technology provides a process for preparing a salt of a hydroxy-substituted (di)ester of phosphoric acid, comprising: (a) reacting a phosphating agent with a monohydric alcohol and with propylene glycol, wherein the mole ratio of monohydric alcohol : propylene glycol is greater than about 4:1 and wherein an excess of the phosphating agent is employed such that the product mixture formed thereby contains phosphorus acid functionality; and (b) reacting the product mixture of step (a) with an amine.

The phosphating agent which may be employed is typically phosphorus pentoxide or a reactive equivalent thereof. Phosphorus pentoxide is usually referred to as P₂O₅, which is its empirical formula, even though it is believed to consist at least in part of more complex molecules such as P₄O₁₀. Both such materials have phosphorus in its +5 oxidation state. Other phosphorus materials that may be employed include polyphosphoric acid and phosphorus oxytrihalides such as phosphorus oxytrichloride.

The phosphating agent is reacted with a monohydric alcohol and with propylene glycol. The monohydric alcohol may generally have a hydrocarbyl group of 1 to 30 carbon atoms, or typically a hydrocarbyl group having 4 to 20 carbon atoms, such as 6 to 18 or 6 to 12 or 6 to 10 or 12 to 18 or 14 to 18 carbon atoms. The monohydric alcohol may be linear or branched; it may likewise be saturated or unsaturated.

As used in this specification, the term “hydrocarbyl substituent” or “hydrocarbyl group” is used in its ordinary sense, which is well-known to those skilled in the art. Specifically, it refers to a group having a carbon atom directly attached to the remainder of the molecule (in the case of an alcohol, directly attached to the —OH group of the alcohol) and having predominantly hydrocarbon character. Examples of hydrocarbyl groups include:

hydrocarbon substituents, that is, aliphatic (e.g., alkyl or alkenyl), alicyclic (e.g., cycloalkyl, cycloalkenyl) substituents, and aromatic-, aliphatic-, and alicyclic-substituted aromatic substituents, as well as cyclic substituents wherein the ring is completed through another portion of the molecule (e.g., two substituents together form a ring);

substituted hydrocarbon substituents, that is, substituents containing non-hydrocarbon groups which, in the context of this invention, do not alter the predominantly hydrocarbon nature of the substituent (e.g., halo (especially chloro and fluoro), hydroxy, alkoxy, mercapto, alkylmercapto, nitro, nitroso, and sulfoxy);

hetero substituents, that is, substituents which, while having a predominantly hydrocarbon character, in the context of this invention, contain other than carbon in a ring or chain otherwise composed of carbon atoms and encompass substituents as pyridyl, furyl, thienyl and imidazolyl. Heteroatoms include sulfur, oxygen, and nitrogen. In general, no more than two, or no more than one, non-hydrocarbon substituent will be present for every ten carbon atoms in the hydrocarbyl group; alternatively, there may be no non-hydrocarbon substituents in the hydrocarbyl group.

Suitable monohydric alcohols include various isomers of octyl alcohols, such as, notably, 2-ethylhexanol. Other examples of suitable alcohols include butanol, pentanol, hexanol, heptanol, octanol, nonanol, decanol, dodecanol, tridecanol, tetradecanol, pentadecanol, hexadecanol, heptadecanol, octadecanol, octadecenol (oleyl alcohol), nonadecanol, eicosyl-alcohol, and mixtures thereof.

Examples of suitable alcohols include, for example, 4-methyl-2-pentanol, 2-ethylhexanol, isooctanol, and mixtures thereof.

Examples of commercially available alcohols include Oxo Alcohol® 7911, Oxo Alcohol® 7900 and Oxo Alcohol® 1100 of Monsanto; Alphanol® 79 of ICI; Nafol® 1620, Alfol® 610 and Alfol® 810 of Condea (now Sasol); Epal® 610 and Epal® 810 of Afton Corporation; Linevol® 79, Linevol® 911 and Dobanol® 25 L of Shell AG; Lial® 125 of Condea Augusta, Milan; Dehydad® and Lorol® of Henkel KGaA (now Cognis) as well as Linopol® 7-11 and Acropol® 91 of Ugine Kuhlmann.

The phosphating agent is also reacted with propylene glycol. In one notable embodiment, the propylene glycol comprises 1,2-propanediol.

The relative amounts of the monohydric alcohol and the propylene glycol are selected such that the mole ratio of monohydric alcohol : propylene glycol is greater than to 4:1, or, in other embodiments, 8:2, or about 5.5:1 to about 7:1. In yet other embodiments, the mole ratio of monohydric alcohol : propylene glycol can be about 8.4:1.6 to about 8.9:1.1. If expressed on an equivalent basis, a 1:1 mole ratio of monool:diol would correspond to a 1:2 ratio of —OH groups. Thus, when approximately equal molar amounts of monohydric alcohol and propylene glycol are used, there will be more hydroxy groups contributed by the diol than by the monohydric alcohol.

The monohydric alcohol and propylene glycol are reacted with the phosphating agent (which is alternatively known as a phosphorylating agent) in such overall amounts that the product mixture formed thereby contains phosphorus acid functionality. That is, the phosphating agent is not completely converted to its ester form but will retain at least a portion of P—OH acidic functionality, which may, if desired, be accomplished by using a sufficient amount of the phosphating agent compared with the equivalent amounts of the alcohol and polyol. In particular, in certain embodiments the phosphating agent (which may comprise phosphorus pentoxide) may be reacted with the monohydric alcohol and the propylene glycol in a ratio of 1 to 3 or 1 to 2.5 (or 1.25 to 2 or 1.5 to 2.5 or 2.5 to 3.5) moles of hydroxyl groups per 1 mole of phosphorus from the phosphating agent. In other embodiments, the phosphating agent may be reacted with the monohydric alcohol and the propylene glycol in a ratio of 1 to 1.75 moles of the total of monohydric alcohol plus propylene glycol per phosphorus atom of the phosphating agent. If the phosphating agent is taken to be phosphorus pentoxide, P₂O₅, such that there are two P atoms per mole of phosphating agent, this ratio may be expressed as 2 to 3.5 moles of (alcohol+polyol) per mole of P₂O₅. In other embodiments, 2.5 to 3.5, or 2.5 to 3.0 moles of the total alcohol and polyol may be used per mole of phosphorus pentoxide. In yet other embodiments, 3.0 moles of the total alcohol and polyol may be used per mole of phosphorus pentoxide. (This assumes that phosphorus pentoxide has the formula P₂O₅, rather than the alternative formula P₄O₁₀; appropriate ratios may be readily calculated corresponding to either formula.) The number of alcoholic OH groups per P atom may also depend on the relative amounts of the monool and diol (or higher alcohols) employed. If there is a 1:1 mole ratio of monool and diol, for instance, there will be 1.5 OH groups per mole of total alcohols, and the above-stated range of 1 to 1.75 moles of alcohols per P atom would correspond to 1.5 to 2.625 OH groups per P atom.

In one somewhat oversimplified schematic representation, the reaction of the phosphating agent with alcohol(s) may be represented as follows:

3ROH+P₂O₅→(RO)₂P(═O)OH+RO—P(═O)(OH)₂

where ROH represent a monohydric alcohol or part of a propylene glycol, or two R groups may together represent the propylene portion of propylene glycol. As will be seen below, the residual phosphoric acidic functionality may be reacted at least in part with an amine.

The phosphating agent may be mixed with and reacted with the monohydric alcohol and the propylene glycol in any order. In certain embodiments, the total charge of the phosphating agent is reacted with the total charge of the monohydric alcohol plus the propylene glycol in a single mixture.

The phosphating agent itself may also be introduced into the reaction mixture in a single portion, or it may be introduced in multiple portions. Thus, in one embodiment, a reaction product (or intermediate) is prepared wherein a portion of the phosphating agent is reacted with the monohydric alcohol and the propylene glycol and thereafter a second charge of the phosphating agent is added.

The reaction product from the phosphating agent and the monohydric alcohol and the propylene glycol will be a mixture of individual species, and the particular detailed compositions may depend, to some extent, on the order of addition of the reactants. The reaction mixture, however, will typically contain at least some molecules represented by the formulas (I) or (II)

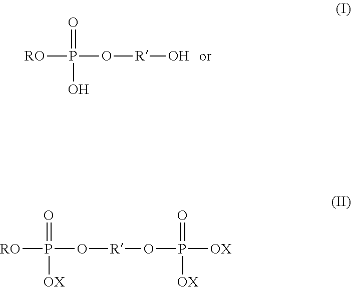

where R is an alkyl group or a hydrocarbyl group provided by the monohydric alcohol, R′ is an alkylene group provided by the alkylene diol, and each X is independently R, or H, or an —R′OH group, provided that at least one X is H. In the instance where the alkylene diol is 1,2-propanediol, the corresponding structures may be represented by

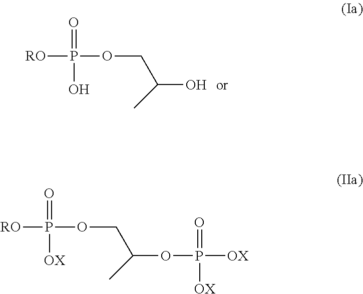

(Either orientation of the propylene glycol moiety is permitted; the methyl group may alternatively be on the other carbon atom.)

There may be a variable amount of products represented by other structures, such as partially esterified materials; or fully esterified materials:

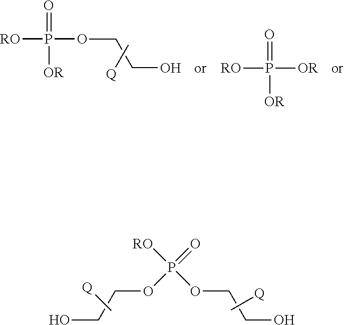

including cyclic esters such as:

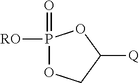

and others containing more than one unit in the ring derived from propylene glycol, as well as materials with a P—O—P linkage (pyrophosphates). There will also likely be some longer chain materials having a higher degree of condensation such as:

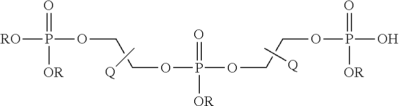

where R is an alkyl group having 4 to 20 carbon atoms, each Q is methyl, and each X is independently R, or H, or a —R′OH group where R′ is derived from propylene glycol, provided that at least one X is H, further provided that said composition is substantially free from species containing a dimeric or oligomeric moiety derived from the dimerization of oligomerization of an alkylene oxide.

The product of the reaction as described herein, however, will likely contain little or no material containing (ether type) alkylene oxide dimers or oligomers or alkylene glycol (or diol) dimers or oligomers (initiated by a phosphorus acid). Such dimeric or oligomeric materials are likely to be formed when an alkylene oxide is employed in place of the alkylene diol of the present technology. The technology of the present invention provides materials that are characterized by a lesser amount of “alkylene oxide” (or “ether type”) dimers or oligomers and thus are particularly useful in providing antiwear performance when converted to the amine salts as set forth below. In certain embodiments the reaction product is substantially free from species containing a dimeric or oligomeric moiety deriving from the dimerization or oligomerization of an alkylene oxide. By “substantially free” is meant that species containing such dimeric or oligomeric moieties may account for less than 5 percent by weight, or less than 1 percent by weight, or less than 0.1 percent by weight, or 0.01 to 0.05 percent by weight of all the phosphorus-containing species.

The reaction of the phosphating agent with the monohydric alcohol and the propylene glycol may be affected by reacting a mixture of the reactants at 40 to 110° C., or 40 to 90° C., for 1 to 10, or 2 to 8, or 3 to 5 hours. The process may be carried out at reduced pressure, atmospheric pressure or above atmospheric pressure. Any water of reaction may be removed by distillation or purging with inert gas.

The product or intermediate prepared from the reaction of the phosphating agent and a monohydric alcohol and a propylene glycol is further reacted with an amine, to form a mixture of materials that may be characterized as comprising an amine salt or salts; it may also contain materials characterized by the presence of a P—N bond. The product includes amine salts of a primary amine, a secondary amine, a tertiary amine, or mixtures thereof. In one embodiment the primary amine includes a tertiary-aliphatic primary amine. In one embodiment the amine is not an aromatic amine and, in another embodiment, it does not contain the amine nitrogen within a heterocyclic ring. In one embodiment the amine is an alkylamine, such as a dialkylamine or a monoalkylamine. A suitable dialkylamine (that is, a secondary amine) may be bis-2-ethylhexylamine. A suitable monoalkylamine (that is, a primary amine) may be 2-ethylhexylamine. In certain embodiments, the amine comprises at least one alkyl primary amine or at least one alkyl secondary amine. In one embodiment the amine comprises at least one alkyl primary amine having 6 to 18 carbon atoms. A proper selection of amine, as set forth above, can assure a product of comparatively low toxicity.

Examples of suitable primary amines include ethylamine, propylamine, butylamine, 2-ethylhexylamine, octylamine, and dodecylamine, as well as such fatty amines as n-octylamine, n-decylamine, n-dodecylamine, n-tetradecylamine, n-hexadecylamine, n-octadecylamine and oleylamine. Other useful fatty amines include commercially available fatty amines such as “Armeen®” amines (products available from Akzo Chemicals, Chicago, Ill.), such as Armeen C, Armeen O, Armeen OL, Armeen T, Armeen HT, Armeen S and Armeen SD, wherein the letter designation relates to the fatty group, such as coco, oleyl, tallow, or stearyl groups.

Examples of suitable secondary amines include dimethylamine, diethylamine, dipropylamine, dibutylamine, diamylamine, dihexylamine, diheptylamine, bis-2-ethylhexylamine, methylethylamine, ethylbutylamine, N-methyl-1-amino-cyclohexane, Armeen® 2C and ethylamylamine. The secondary amines may be cyclic amines such as piperidine, piperazine and morpholine. Examples of tertiary amines include tri-n-butylamine, tri-n-octylamine, tri-decylamine, tri-laurylamine, tri-hexadecylamine, and dimethyloleylamine (Armeen® DMOD).

In one embodiment the amines are in the form of a mixture. Examples of suitable mixtures of amines include (i) an amine with 11 to 14 carbon atoms on tertiary alkyl primary groups (that is, a primary amine with 11 to 14 carbon atoms in a tertiary alkyl group), (ii) an amine with 14 to 18 carbon atoms on tertiary alkyl primary groups (that is, a primary amine with 14 to 18 carbon atoms in a tertiary alkyl group), or (iii) an amine with 18 to 22 carbon atoms on tertiary alkyl primary groups (that is, a primary amine with 18 to 22 carbon atoms in a tertiary alkyl group). Other examples of tertiary alkyl primary amines include tert-butylamine, tert-hexylamine, tert-octylamine (such as 1,1-dimethylhexylamine), tert-decylamine (such as 1,1-dimethyloctylamine), tert-dodecylamine, tert-tetradecylamine, tert-hexadecylamine, tert-octadecylamine, tert-tetracosanylamine, and tert-octacosanylamine. In one embodiment a useful mixture of amines is “Primene® 81R” or “Primene® JMT.” Primene® 81R and Primene® JMT (both produced and sold by Rohm & Haas) are mixtures of C11 to C14 tertiary alkyl primary amines and C18 to C22 tertiary alkyl primary amines respectively.

In certain embodiments the amine will comprise at least one secondary amine having 10 to 22 carbon atoms, or 12 to 20, or 14 to 18, or 16 carbon atoms, total. In certain embodiments the secondary amine will contain two alkyl groups, each having 5 to 11 carbon atoms, or 6 to 10, or 7 to 9 carbon atoms. An example is bis-2-ethylhexyl amine.

Additional exemplary amines include a-methylbenzylamine, tert-butylamine, tert-octylamine, and combinations thereof.

In certain embodiments, the amount of amine employed in preparing the mixture of the disclosed technology will be the amount required to neutralize, in theory, all or substantially all of the acidity of the above-described phosphorus product, e.g., 90-100% or 92-98% or about 95% of the acidity. In one embodiment, as an example, the amount of acidity of the phosphorus product may be determined by titration using bromophenol blue indicator, and the amount of amine employed may be 95 percent, on an equivalent basis, of the amount of acidity determined to be present. The amount of acidity may be expressed as Total Acid Number, TAN (AS™ D 663 or 664 or 974), if desired.

In certain embodiments the amine salt will comprise a mixture of materials which will include some molecules represented by a somewhat idealized structure of formula (III)

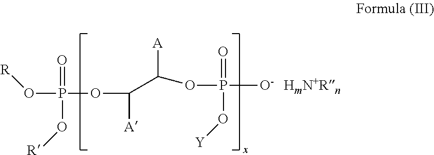

wherein A and A′ are independently H, or a methyl group; each R and R″ group are independently a hydrocarbyl group; each R′ is independently R, H, or a hydroxyalkyl group; Y is independently R′ or a group represented by RO(R′O)P(O)O—CH(A′)CH(A)-(such as RO(R′O)P(O)O—CH₂CH(CH₃)—); x is 0 to 3, provided that when x=0, R′ is a hydroxyalkyl group; and m and n are both positive non-zero integers, provided that the sum of (m+n) is equal to 4. In one embodiment, x=0 and each R′ is independently R, H, or a hydroxyalkyl group.

It is evident that the anionic portion of formula (III), on the left, is a representation of an anion derived from a material of formula (I), (Ia), (II), or (IIa), and each of the foregoing representations and descriptions in connection with those formulas will also be applicable to the anionic portion of formula (III). Likewise, the cationic portion of formula (III), on the right, is a representative of a cation derived from an amine as described above.

In some embodiments, the salt may be prepared using an amine ester. The amine ester may be prepared by mixing itaconic acid with an alcohol and an amine. Suitable amines for forming the amine ester include the amines described above. The amine ester is then added to product or intermediate prepared from the reaction of the phosphating agent and a monohydric alcohol and a propylene glycol to form an amine phosphate salt.

It is known that some of the materials described above may interact in the final formulation, so that the components of the final formulation may be different from those that are initially added. For instance, metal ions (of, e.g., a detergent) can migrate to other acidic or anionic sites of other molecules, such as the product described above. The products formed thereby, including the products formed upon employing the composition of the present invention in its intended use, may not be susceptible of easy description. Nevertheless, all such modifications and reaction products are included within the scope of the present technology; the present technology encompasses the composition prepared by admixing the components described herein.

The amine salt compositions described above will typically be used in a lubricant composition. Its amount will typically be the amount suitable to provide antiwear performance to the lubricant. Such amounts may typically be 0.3 to 3 percent by weight, or 0.5 to 1 percent, or greater than 1 to 1.9 percent, or 1.1 to 1.8 percent, or 1.2 to 1.8 percent, or 1.3 to 1.7 percent or even, in certain embodiments, 1.44 to 1.62 percent by weight.

### Oil of Lubricating Viscosity

One of the components of a lubricant composition is an oil of lubricating viscosity. These include natural and synthetic oils of lubricating viscosity, oils derived from hydrocracking, hydrogenation, or hydrofinishing, and unrefined, refined, and re-refined oils and mixtures thereof.

Natural oils include animal oils, vegetable oils, mineral oils and mixtures thereof. Synthetic oils include hydrocarbon oils, silicon-based oils, and liquid esters of phosphorus-containing acids. Synthetic oils may be produced by Fischer-Tropsch gas-to-liquid synthetic procedure as well as other gas-to-liquid oils. In one embodiment the composition of the present invention is useful when employed in a gas-to-liquid oil. Often Fischer-Tropsch hydrocarbons or waxes may be hydroisomerized. In one embodiment the base oil comprises a polyalphaolefin including a PAO-2, PAO-4, PAO-5, PAO-6, PAO-7, or PAO-8. The polyalphaolefin in one embodiment is prepared from dodecene and in another embodiment from decene. In one embodiment the oil of lubricating viscosity comprises an ester such as an adipate.

Oils of lubricating viscosity may also be defined as specified in the American Petroleum Institute (API) Base Oil Interchangeability Guidelines.

| Base Oil Category | Sulfur (%) | Saturates (%) | Viscosity Index |
|---|---|---|---|
| Group I | >0.03 and/or | <90 | 80 to less than 120 |
| Group II | ≤0.03 and | ≥90 | 80 to less than 120 |
| Group III | ≤0.03 and | ≥90 | ≥120 |

| | |
|---|---|
| Group IV | All polyalphaolefins (PAOs) |
| Group V | All others not included in Groups I, II, III or IV |

Groups I, II and III are mineral oil base stocks. Other generally recognized categories of base oils may be used, even if not officially identified by the API: Group II+, referring to materials of Group II having a viscosity index of 110-119 and lower volatility than other Group II oils; and Group III+, referring to materials of Group III having a viscosity index greater than or equal to 130. The oil of lubricating viscosity can include natural or synthetic oils and mixtures thereof. Mixture of mineral oil and synthetic oils, e.g., polyalphaolefin oils and/or polyester oils, may be used.

In one embodiment the oil of lubricating viscosity comprises an API

Group I, II, III, IV, V, VI base oil, or mixtures thereof, and in another embodiment API Group II, III, IV base oil or mixtures thereof. In another embodiment the oil of lubricating viscosity is a Group III or IV base oil and in another embodiment a Group IV base oil.

The amount of the oil of lubricating viscosity present is typically the balance remaining after subtracting from about 100 wt % the sum of the amount of the compounds of the present technology and other listed components such as friction modifier, conventional phosphorus antiwear and/or extreme pressure agent, organo-sulfide, and other performance additives. In one embodiment the lubricating composition is in the form of a concentrate and/or a fully formulated lubricant. If the phosphorus containing additive and any other performance additives are in the form of a concentrate (which may be combined with additional oil to form, in whole or in part, a finished lubricant), the ratio of the sum of the components of the lubricating composition to the oil of lubricating viscosity and/or to diluent oil include the ranges of 1:99 to about 99:1 by weight, or 80:20 to 10:90 by weight.

In one embodiment the oil of lubricating viscosity has a kinematic viscosity at 100° C. by AS™ D445 of 3 to 7.5, or 3.6 to 6, or 3.5 to 6, or 3.5 to 5 mm²/s. In one embodiment the oil of lubricating viscosity comprises a poly alpha olefin having a kinematic viscotiy at 100° C. by AS™ D445 of 3 to 7.5 or any of the other aforementioned ranges.

The lubricant formulation may contain a viscosity modifier (which is sometimes counted as a part of the oil of lubricating viscosity component). Viscosity modifiers (VM) and dispersant viscosity modifiers (DVM) are well known. Examples of VMs and DVMs may include polymethacrylates, polyacrylates, polyolefins, styrene-maleic ester copolymers, and similar polymeric substances including homopolymers, copolymers, and graft copolymers. The DVM may comprise a nitrogen-containing methacrylate polymer, for example, a nitrogen-containing methacrylate polymer derived from methyl methacrylate and dimethylaminopropyl amine.

Examples of commercially available VMs, DVMs and their chemical types may include the following: polyisobutylenes (such as Indopol™ from BP Amoco or Parapol™ from ExxonMobil); olefin copolymers (such as Lubrizol™ 7060, 7065, and 7067 from Lubrizol and Lucant™ HC-2000L and HC-600 from Mitsui); hydrogenated styrene-diene copolymers (such as Shellvis™ 40 and 50, from Shell and LZ® 7308, and 7318 from Lubrizol); styrene/maleate copolymers, which are dispersant copolymers (such as LZ® 3702 and 3715 from Lubrizol); polymethacrylates, some of which have dispersant properties (such as those in the Viscoplex™ series from RohMax, the Hitec™ viscosity modifiers from Afton, and LZ® 7702, LZ® 7727, LZ® 7725, LZ® 7720C, and LZ® 7723 from Lubrizol); olefin-graft-polymethacrylate polymers (such as Viscoplex™ 2-500 and 2-600 from RohMax); and hydrogenated polyisoprene star polymers (such as Shellvis™ 200 and 260, from Shell). Viscosity modifiers that may be used are described in U.S. Pat. Nos. 5,157,088, 5,256,752 and 5,395,539. Other viscosity modifiers include a olefin-maleic anhydride ester copolymers, as disclosed in PCT publication WO2010/014655. The VMs and/or DVMs may be used in the functional fluid at a concentration of up to 20% by weight or even up to 60% or 70% by weight. Concentrations of 1 to 12%, or 3 to 10%, by weight may also be used.

The lubricant formulation may contain, in addition to the phosphorus salt composition described above, one or more conventional phosphorus antiwear agents and/or extreme pressure agents. Alternatively, the lubricant formulation may be free from such conventional agents. The conventional phosphorus antiwear and/or extreme pressure agent may be present in an amount of 0 wt % to 10 wt %, 0 wt % to 8 wt %, 0 wt % to 6 wt %, 0.05 wt % to 2.5 wt %, 1 wt % to 2 wt %, and 0.05 wt % to 4 wt % of the lubricating composition. Suitable agents include those described in U.S. Pat. No. 3,197,405; see for instance examples 1 to 25 thereof. For automotive gear oils, the phosphate content may be 200 to 3,000 ppm, 500 to 2,000 ppm, or 1,000 to 1,800 ppm of the lubricating composition. For manual transmission fluids, the phosphate content may be 500 to 1,000 ppm, 400 to 1,500 ppm, or 450 to 1,250 ppm of the lubricating composition. For axle lubricants, the phosphate content may be 400 to 3,000 ppm, 500 to 2,000 ppm, or 1,000 to 1,800 ppm of the total lubricating composition.

The conventional phosphorus antiwear agent may include a non-ionic phosphorus compound, an amine salt of a phosphorus compound other than those disclosed above (such as an amine salt of a mixture of monoalkyl and dialkyl phosphoric acid esters), an ammonium salt of a phosphorus compound other than those disclosed above, a metal dialkyldithiophosphate, a metal dialkylphosphate, or mixtures thereof. In one embodiment the conventional phosphorus antiwear or extreme pressure agent is selected from the group consisting of non-ionic phosphorus compound, a metal dialkyldithiophosphate, a metal dialkylphosphate, and mixtures thereof.

In one embodiment the conventional phosphorus antiwear agent includes a metal dialkyldithiophosphate. The alkyl groups of the dialkyldithiophosphate may be linear or branched and may contain 2 to 20 carbon atoms, provided that the total number of carbons is sufficient to make the metal dialkyldithiophosphate oil soluble. The metal of the metal dialkyldithiophosphate typically includes monovalent or divalent metals. Examples of suitable metals include sodium, potassium, copper, calcium, magnesium, barium, or zinc. In one embodiment the phosphorus-containing acid, salt or ester is a zinc dialkyldithiophosphate. Examples of suitable zinc dialkylphosphates (often referred to as ZDDP, ZDP or ZDTP) include zinc di-(2-methylpropyl) dithiophosphate, zinc di-(amyl) dithiophosphate, zinc di-(1,3-dimethylbutyl) dithiophosphate, zinc di-(heptyl) dithiophosphate, zinc di-(octyl) dithiophosphate, zinc di-(2-ethylhexyl) dithiophosphate, zinc di-(nonyl) dithiophosphate, zinc di-(decyl) dithiophosphate, zinc di-(dodecyl) dithiophosphate, zinc di-(dodecylphenyl) dithiophosphate, zinc di-(heptylphenyl) dithiophosphate, and ZDDPs prepared from mixed alcohols such as methylpropyl and amyl alcohols, 2-ethylhexyl and isopropyl alcohols, or 4-methyl-2-pentyl and isopropyl alcohols; or mixtures thereof.

In one embodiment the conventional phosphorus antiwear agent includes a metal hydrocarbylphosphate or dihydrocarbylphosphate. The hydrocarbyl group of the metal dialkylphosphate includes a straight-chain or a branched alkyl group, a cyclic alkyl group, a straight-chain or a branched alkenyl group, an aryl group, or an arylalkyl group. In one embodiment the hydrocarbyl group of the metal dialkylphosphate is an oil soluble alkyl group. The alkyl group typically includes about 1 to about 40, or about 4 to about 40, or about 4 to about 20, or about 6 to about 16 carbon atoms. Examples of suitable hydrocarbyl or alkyl groups are listed in WO 2008/094759, paragraphs 0069 through 0076.

In one embodiment the metal hydrocarbylphosphate or dihydrocarbylphosphate includes a metal salt of a mono-alkyl phosphate, and in another embodiment a metal salt of a di-alkyl phosphate. In one embodiment the metal of the metal hydrocarbylphosphate or dihydrocarbylphosphate is a monovalent metal, in another embodiment the metal is divalent, and in another embodiment the metal is trivalent. The metal of the metal hydrocarbylphosphate or dihydrocarbylphosphate may include aluminum, calcium, magnesium, strontium, chromium, iron, cobalt, nickel, zinc, tin, manganese, silver, or mixtures thereof. In one embodiment the metal is zinc.

In one embodiment the lubricating composition further comprises extreme pressure agents. Suitable extreme pressure agents include organo-sulfides. In one embodiment the organo-sulfide comprises at least one of a polysulfide, thiadiazole compound, or mixtures thereof. In different embodiments, the organo-sulfide is present in a range of 0 wt % to 10 wt %, 0.01 wt % to 10 wt %, 0.1 wt % to 8 wt %, 0.25 wt % to 6 wt %, 2 wt % to 5 wt %, or 3 wt % to 5 wt % of the lubricating composition. For automotive gear oils, the sulfur content may be 100 to 40,000 ppm, 200 to 30,000 ppm, or 300 to 25,000 ppm of the lubricating composition. For manual transmission fluids, the sulfur content may be 500 to 5,000 ppm, 1,500 to 4,000 ppm, 2,500 to 3,000 ppm of the lubricating composition. For axle lubricants, the sulfur content may be 5,000 to 40,000 ppm, 10,000 to 30,000 ppm, or 12,000 to 25,000 ppm of the total lubricating composition.

Examples of a thiadiazole include 2,5-dimercapto-1,3,4-thiadiazole, or oligomers thereof, a hydrocarbyl-substituted 2,5-dimercapto-1,3,4-thiadiazole, a hydrocarbylthio-substituted 2,5-dimercapto-1,3,4-thiadiazole, or oligomers thereof.

The oligomers of hydrocarbyl-substituted 2,5-dimercapto-1,3,4-thiadiazole typically form by forming a sulfur-sulfur bond between 2,5-dimercapto-1,3,4-thiadiazole units to form oligomers of two or more of said thiadiazole units. Further examples of thiadiazole compounds are found in WO 2008/094759, paragraphs 0088 through 0090.

The organosulfide may alternatively be a polysulfide. In one embodiment at least about 50 wt % of the polysulfide molecules are a mixture of tri- or tetra-sulfides. In other embodiments at least about 55 wt %, or at least about 60 wt % of the polysulfide molecules are a mixture of tri- or tetra-sulfides. The polysulfides include sulfurized organic polysulfides from oils, fatty acids or ester, olefins or polyolefins.

Oils which may be sulfurized include natural or synthetic oils such as mineral oils, lard oil, carboxylate esters derived from aliphatic alcohols and fatty acids or aliphatic carboxylic acids (e.g., myristyl oleate and oleyl oleate), and synthetic unsaturated esters or glycerides.

Fatty acids include those that contain 8 to 30, or 12 to 24 carbon atoms. Examples of fatty acids include oleic, linoleic, linolenic, and tall oil. Sulfurized fatty acid esters prepared from mixed unsaturated fatty acid esters such as are obtained from animal fats and vegetable oils, including tall oil, linseed oil, soybean oil, rapeseed oil, and fish oil.

The polysulfide may also be derived from an olefin derived from a wide range of alkenes, typically having one or more double bonds. The olefins in one embodiment contain 3 to 30 carbon atoms. In other embodiments, olefins contain 3 to 16, or 3 to 9 carbon atoms. In one embodiment the sulfurized olefin includes an olefin derived from propylene, isobutylene, pentene, or mixtures thereof. In one embodiment the polysulfide comprises a polyolefin derived from polymerizing, by known techniques, an olefin as described above. In one embodiment the polysulfide includes dibutyl tetrasulfide, sulfurized methyl ester of oleic acid, sulfurized alkylphenol, sulfurized dipentene, sulfurized dicyclopentadiene, sulfurized terpene, and sulfurized Diels-Alder adducts; phosphosulfurized hydrocarbons.

In one embodiment the lubricating composition further comprises a friction modifier. In different embodiments, the friction modifier is present in an amount of 0 wt % to 7 wt %, 0.1 wt % to 6 wt %, 0.25 wt % to 5 wt %, or 0.5 wt % to 5 wt % of the lubricating composition.

The friction modifier includes fatty amines, borated glycerol esters, fatty acid amides, non-borated fatty epoxides, borated fatty epoxides, alkoxylated fatty amines, borated alkoxylated fatty amines, metal salts of fatty acids, fatty imidazolines, metal salts of alkyl salicylates (which may also be referred to as a detergent), metal salts of sulfonates (which may also be referred to as a detergent), condensation products of carboxylic acids or polyalkylene-polyamines, or amides of hydroxyalkyl compounds. In one embodiment the friction modifier includes a fatty acid ester of glycerol. The fatty acids may contain 6 to 24, or 8 to 18 carbon atoms.

In one embodiment the friction modifier may comprise the product of isostearic acid with tetraethylenepentamine. A more detailed list of possible friction modifiers is found in WO 2008/094759, paragraphs 0100 through 0113.

The composition of the invention optionally further includes at least one other performance additive. The other performance additives include metal deactivators, detergents, dispersants, borated dispersants, antioxidants, corrosion inhibitors, foam inhibitors, demulsifiers, pour point depressants, seal swelling agents, and mixtures thereof. Foam inhibitors may be useful in that, in some embodiments, the phosphorus compounds of the present technology may tend to lead to enhanced foam formation, particularly when the phosphorus compounds are present in higher concentrations, such as 0.5 percent or greater, or 1.0 percent or greater, e.g. 1.1 to 3 percent by weight. In different embodiments, the total combined amount of the other performance additive compounds is present at 0 wt % to 25 wt %, about 0.1 wt % to 15 wt %, or 0.5 wt % to 10 wt %, of the lubricating composition. Although one or more of the other performance additives may be present, it is common for the other performance additives to be present in different amounts relative to each other.

Antioxidants include molybdenum compounds such as molybdenum dithiocarbamates, sulfurized olefins, hindered phenols, aminic compounds such as alkylated diphenylamines (typically di-nonyl diphenylamine, octyl diphenylamine, or di-octyl diphenylamine).

Detergents include neutral or overbased detergents, Newtonian or non-Newtonian, basic salts of alkali, alkaline earth or transition metals with one or more of a phenate, a sulfurized phenate, a sulfonate, a carboxylic acid, a phosphorus acid, a mono- and/or a di-thiophosphoric acid, a saligenin, an alkylsalicylate, and a salixarate.

Dispersants include N-substituted long chain alkenyl succinimides, as well as Mannich condensation products as well as post-treated versions thereof. Post-treated dispersants include those by reaction with urea, thiourea, dimercaptothiadiazoles, carbon disulfide, aldehydes, ketones, carboxylic acids, hydrocarbon-substituted succinic anhydrides, nitriles, epoxides, boron compounds, and phosphorus compounds. In one embodiment the dispersant includes a borated polyisobutylene succinimide. Typically the number average molecular weight of the polyisobutylene ranges from about 450 to 5000, or 550 to 2500. In different embodiments, the dispersant is present in an amount of 0 wt % to 10 wt %, 0.01 wt % to 10 wt %, or 0.1 wt % to 5 wt % of the lubricating composition.

Corrosion inhibitors include octylamine octanoate, condensation products of dodecenyl succinic acid or anhydride, condensation products of a fatty acid such as oleic acid with a polyamine, or a thiadiazole compound described above. Metal deactivators include derivatives of benzotriazoles (typically tolyltriazole), 1,2,4-triazoles, benzimidazoles, 2-alkyldithiobenzimidazoles or 2-alkyldithiobenzothiazoles.

Foam inhibitors include copolymers of ethyl acrylate and 2-ethylhexylacrylate and optionally vinyl acetate. Demulsifiers include trialkyl phosphates, polyethylene glycols, polyethylene oxides, polypropylene oxides and (ethylene oxide-propylene oxide) polymers. Pour point depressants include esters of maleic anhydride-styrene, polymethacrylates, polyacrylates, or polyacrylamides.

Seal swell agents include Exxon Necton-37™ (FN 1380) and Exxon Mineral Seal Oil (FN 3200).

In one embodiment the lubricating composition described herein may be a grease, and such compositions typically will further comprise a grease thickener. The grease thickener includes materials derived from (i) inorganic powders such as clay, organo-clays, bentonite, fumed silica, calcite, carbon black, pigments, copper phthalocyanine or mixtures thereof, (ii) a carboxylic acid and/or ester (such as a mono- or poly-carboxylic acid and/or ester thereof), (iii) a polyurea or diurea, or (iv) mixtures thereof. A detailed description of specific grease thickeners is found in WO 2008/094759, paragraphs 0135 through 0145. A grease composition may also contain one or more metal deactivators, antioxidants, antiwear agents, rust/corrosion inhibitors, viscosity modifiers, extreme pressure agents (as described above) or a mixture of two or more thereof.

### Methods and Application

In one embodiment the disclosed technology provides for the use of the lubricating composition disclosed herein in gears and transmissions to impart at least one of antiwear performance, extreme pressure performance, acceptable deposit control, acceptable oxidation stability, and reduced odor.

In one embodiment, the component is a drivetrain component comprising at least one of a transmission, manual transmission, gear, gearbox, axle gear, automatic transmission, a dual clutch transmission, or combinations thereof. In another embodiment, the transmission may be an automatic transmission or a dual clutch transmission (DCT). Additional exemplary automatic transmissions include, but are not limited to, continuously variable transmissions (CVT), infinitely variable transmissions (IVT), toroidal transmissions, continuously slipping torque converted clutches (CSTCC), and stepped automatic transmissions.

Alternatively, the transmission may be a manual transmission (MT) or gear.

In yet another embodiment, the component may be a farm tractor or off-highway vehicle component comprising at least one of a wet-brake, a transmission, a hydraulic, a final drive, a power take-off system, or combinations thereof.

In different embodiments, the lubricating composition may have a composition as described in Table 1. The weight percents (wt %) shown in Table 1 below are on an actives basis.

TABLE 1

| | Embodiments (wt %) | | |
|---|---|---|---|
| | | Off- | |
| | | highway | |
| Additive | DCT fluid | fluid | MT fluid |
| Phosphate Salts | 0.01 to 3 | 0.01 to 3 | 0.01 to 3 |
| Dispersant | 0.05 to 4 | 0 to 5 | 1 to 6 |
| Extreme Pressure Agent | 0 to 0.5 | 0 to 3 | 0 to 6 |
| Overbased Detergent | 0 to 1 | 0.5 to 6 | 0.01 to 2 |
| Antioxidant | 0 to 2 | 0 to 3 | 0 to 2 |
| Antiwear Agent | 0.5 to 3 | 0.5 to 3 | 0.01 to 3 |
| (other than | | | |
| Phosphate Salts) | | | |
| Friction modifiers | 0 to 5 | 0.1 to 1.5 | 0 to 5 |
| Viscosity Modifier | 0.1 to 15 | 1 to 60 | 0.1 to 70 |
| Any other | 0 to 10 | 0 to 6 | 0 to 10 |
| performance additive | | | |
| Oil of lubricating | Balance to 100% | Balance to 100% | Balance to 100% |
| viscosity | | | |

The amount of each chemical component described is presented exclusive of any solvent or diluent oil, which may be customarily present in the commercial material, that is, on an active chemical basis, unless otherwise indicated. However, unless otherwise indicated, each chemical or composition referred to herein should be interpreted as being a commercial grade material which may contain the isomers, by-products, derivatives, and other such materials which are normally understood to be present in the commercial grade.

The phosphate salt may also be used in industrial lubricant compositions, such as greases, metal working fluids, industrial gear lubricants, hydraulics oils, turbine oils, circulation oils, or refrigerants. Such lubricant compositions are well known in the art.

In one embodiment, lubricant may be used in a grease. The grease may have a composition comprising an oil of lubricating viscosity, a grease thickener, and 0.001 wt % to 15 wt % of a phosphate salts salt as described above therein. In other embodiments, the phosphate salts salt may be present in the lubricant at 0.01 wt % to 5 wt % or 0.002 to 2 wt %, based on a total weight of the lubricant composition.

In one embodiment, the grease may also be a sulphonate grease. Such greases are known in the art. In another embodiment, the sulphonate grease may be a calcium sulphonate grease prepared from overbasing a neutral calcium sulphonate to form amorphous calcium carbonate and subsequently converting it into either calcite, or vaterite or mixtures thereof.

The grease thickener may be any grease thickener known in the art. Suitable grease thickeners include, but are not limited to, metal salts of a carboxylic acid, metal soap grease thickeners, mixed alkali soaps, complex soaps, non-soap grease thickeners, metal salts of such acid-functionalized oils, polyurea and diurea grease thickeners, or calcium sulphonate grease thickeners. Other suitable grease thickeners include, polymer thickening agents, such as polytetrafluoroethylene, polystyrenes, and olefin polymers. Inorganic grease thickeners may also be used. Exemplary inorganic thickeners include clays, organo-clays, silicas, calcium carbonates, carbon black, pigments or copper phthalocyanine. Further thickeners include urea derivatives, such as polyuria or a diurea. Specific examples of a grease include those summarized in Table 2 below.

TABLE 2
Grease Additive Package Compositions*

| | Embodiments (wt %) | |
|---|---|---|
| Function/Component | Multi-functional | High Temp-Long Life |
| Phosphate Salts | 20-30 | 0.1 to 5.0 |
| Antioxidant | 10 to 20 | 25.0-60.0 |
| Dispersant | 0.50 to 5.0 | — |
| Metal Deactivator | 1.0 to 8.0 | — |
| Antiwear Agent (other than | — | 5.0 to 15.0 |
| Phosphate Salts) | | |
| Extreme Pressure Agent | 45.0 to 65.0 | 0.1 to 10.0 |
| Corrosion inhibitor | 1.0 to 5.0 | 30.0 to 40.0 |
| Diluent Oil | Balance to 100 | Balance to 100% |

*The grease additive package is treated at 2 wt % to 5 wt % of a grease composition.

In different embodiments the technology provides engine oil lubricating compositions that can be employed in internal combustion engines. The internal combustion engine may be spark ignition or compression ignition. The internal combustion engine may be a 2-stroke or 4-stroke engine. The internal combustion engine may be a passenger car engine, a light duty diesel engine, a heavy duty diesel engine, a motorcycle engine, or a 2-stroke or 4-stroke marine diesel engine. Typically, the internal combustion engine may be a passenger car engine, or a heavy duty diesel internal combustion engine.

The lubricant composition for an internal combustion engine may be suitable for any engine lubricant irrespective of the sulfur, phosphorus or sulfated ash (AS™ D-874) content. The lubricating composition may be characterized as having at least one of (i) a sulfur content of 0.2 wt % to 0.4 wt % or less, (ii) a phosphorus content of 0.08 wt % to 0.15 wt %, and (iii) a sulfated ash content of 0.5 wt % to 1.5 wt % or less. The lubricating composition may also be characterized as having (i) a sulfur content of 0.5 wt % or less, (ii) a phosphorus content of 0.1 wt % or less, and (iii) a sulfated ash content of 0.5 wt % to 1.5 wt % or less. In yet another embodiment, the lubricating composition may be characterized as having a sulfated ash content of 0.5 wt % to 1.2 wt %. Specific examples of engine lubricant include those summarized in Table 3 (weight percents are on an actives basis).

TABLE 3

| | Embodiments (wt %) | | |
|---|---|---|---|
| Additive | A | B | C |
| Phosphate Salts | 0.01 to 3 | 0.01 to 3 | 0.01 to 3 |
| Boron-Containing Dispersant | 0.0 to 8 | 0.05 to 4 | 0.05 to 3 |
| Nitrogen-Containing Dispersant | 0.05 to 12 | 0.5 to 8 | 1 to 5 |
| Dispersant Viscosity Modifier | 0 to 5 | 0 to 4 | 0.05 to 2 |
| Overbased Detergent | 0 to 15 | 0.1 to 8 | 0.5 to 3 |
| Antioxidant | 0 to 15 | 0.1 to 10 | 0.5 to 5 |
| Antiwear Agent (other than | 0.1 to 15 | 0.2 to 6 | 0.3 to 2 |
| Phosphate Salts) | | | |
| Friction Modifier | 0 to 6 | 0.05 to 4 | 0.1 to 2 |
| Viscosity Modifier | 0 to 10 | 0.5 to 8 | 1 to 6 |
| Any Other Performance Additive | 0 to 10 | 0 to 8 | 0 to 6 |
| Oil of Lubricating Viscosity | Balance to 100% | Balance to 100% | Balance to 100% |

### EXAMPLES

Preparative Example 1. 4-methyl-2-pentanol (550 g) and 1,2-propanediol (58.5 g) (mole ratio 0.7:0.1) are mixed in a reaction flask and heated under a gentle stream of nitrogen to 70° C. with stirring. Phosphorus pentoxide (290.5 g) is added in several increments with stirring, while maintaining the temperature between 75 and 80° C. Upon completion of the addition of the phosphorus pentoxide, the reaction mixture is heated to 90° C. and maintained at this temperature for 2 hours, and then cooled to 48° C. Approximately one half of the reaction mixture is taken for further reaction; to this amount, bis-2-ethylhexylamine (“Amine 1”) (447.2 g) is added dropwise over a period of 1.5 hours. The resulting mixture is heated to 75° C. and maintained at this temperature for 3 hours. The reaction product is used without further purification.

Preparative Example 2. For this example, the same process is repeated as in Preparative Example 1, except the mole ratio of 4-methyl-2-pentanol to 1,2-propanediol is 0.5:0.1.

Preparative Example 3. For this example, a phosphorus compound is prepared by mixing 2-ethylhexanol and 1,2-propanediol (mole ratio of 0.5:0.1) in a reaction flask and heating under a gentle stream of nitrogen to 70° C. with stirring. Phosphorous pentoxide is added in several increments with stirring. Upon completion of the addition of the phosphorus pentoxide, the reaction mixture is heated to 90° C. and maintained at this temperature for 6 hours. Additional phosphorus pentoxide is added in several increments over a period of 1.5 hours. The reaction mixture is heated to 80° C., stirred for 3 hours, and filtered. The filtrate is heated to 45° C. under a gentle stream of nitrogen.

In a separate vessel, itaconic acid, 2-ethylhexanol and α-methylbenzylamine, are mixed to form an amine ester (“Amine 2”). The amine ester is then added to the phosphorus compound to form an amine phosphate salt.

Preparative Example 4. Preparative Example 4 is prepared the same way as Preparative Example 3, except the amine ester is prepared using tert-butylamine (“Amine 3”). The amine ester is then added to the phosphorus compound to form an amine phosphate salt.

Preparative Example 5. For this example, the same process is repeated as in Preparative Example 4, except 4-methyl-2-pentanol is used instead of 2-ethylhexanol. The mole ratio of 4-methyl-2-pentanol to 1,2-propanediol is 0.5:0.1.

Preparative Example 6. For this example, the same process is repeated as in Preparative Example 3, except that 4-methyl-2-pentanol is used instead of 2-ethylhexanol in the preparation of the phosphorous compound, and the amine ester is prepared using tert-octylamine (“Amine 4”). The mole ratio of 4-methyl-2-pentanol to 1,2-propanediol remains at 0.5:0.1.

Preparative Example 7. 2-ethylhexanol (400 g) and 1,2-propanediol (42.4 g) (ratio of 0.5:0.1) are mixed in a reaction flask and heated under a gentle stream of nitrogen to 70° C. with stirring. Phosphorus pentoxide (171.6 g) is added in several increments with stirring, while maintaining the temperature between 75 and 80° C. Upon completion of the addition of the phosphorus pentoxide, the reaction mixture is heated to 90° C. and maintained at this temperature for 2 hours, and then cooled to 48° C. Approximately one half of the reaction mixture is taken for further reaction; to this amount, bis-2-ethylhexylamine (232.2 g) is added dropwise over a period of 1.5 hours. The resulting mixture is heated to 75° C. and maintained at this temperature for 3 hours. The reaction product is used without further purification.

Comparative Example 1—propylene glycol-free. Isooctanol (Exxal® 8) (700 g) is placed in a reaction flask and heated under a gentle stream of nitrogen to 30° C. with stirring. Phosphorus pentoxide (253.3 g) is added in several increments with stirring, while maintaining the temperature between 65° C. Upon completion of the addition of the phosphorus pentoxide, the reaction mixture is heated to 90° C. and maintained at this temperature for 2-3 hours, and then cooled to 50° C. 2-Ethylhexylamine (472.9 g) is added dropwise over a period of 1.5 hours. The resulting mixture is heated to 75° C. and maintained at this temperature for 3 hours. The reaction product is used without further purification.

Comparative Example 2—propylene glycol-free. For Comparative Example 2, a salt similar to Preparative Example 3 is prepared, but without propylene glycol, and tert-butylamine is used instead of the a-methylbenzylamine to prepare the amine ester. The phosphorus compound is prepared by mixing 2-ethylhexanol and phosphorous pentoxide. In a separate vessel, itaconic acid, 2-ethylhexanol and tert-butylamine are mixed to form an amine ester. The amine ester is then added to the phosphorus compound to form an amine phosphate salt.

Comparative Example 3—high propylene glycol content. Comparative Example 3 is similar to Preparatory Example 1, except that high levels of propylene glycol are used. For Comparative Example 3, 4-methyl-2-pentanol and 1,2-propanediol are mixed in a reaction flask in a ratio of 0.35 to 0.1

Comparative Example 4—switching from 1,2-diol. Comparative Example 4 is similar to Preparatory Example 1, except that 2-butyl-2-ethylpropane-1,3-diol is used instead of the 1,2-propanediol. The ratio of 4-methyl-2-pentanol to 2-butyl-2-ethylpropane-1,3-diol is 0.7:0.1. In this example, 4-methyl-2-pentanol (422 g) and 2-butyl-2-ethylpropane-1,3-diol (95 g) are mixed in a reaction flask and heated under a gentle stream of nitrogen to 55° C. with stirring. Phosphorus pentoxide (224.5 g) is added in several increments with stirring, while maintaining the temperature below 70° C. over a period of 2 hours. Upon completion of the addition of the phosphorus pentoxide, the reaction mixture is heated to 85° C. and maintained at this temperature for 3 hours, and then cooled to room temperature. Approximately 964 g of the reaction mixture is taken for further reaction; to this amount, 2-ethylhexylamine (398 g) is added dropwise over a period of 1.5 hours. The resulting mixture is heated to 85° C. and maintained at this temperature for 3 hours. The reaction product is then filtered using calcined diatomaceous earth.

Comparative Example 5.
Comparative Example 5 is similar to Comparative Example 4, except 2,3-butane diol (63 g) is used. The amount of 4-methyl-2-pentanol is 500 g. To make the salt, 412.6 g of bis-2-ethylhexylamine is used.

The materials of the Preparative, Comparative, and Control materials are used to prepare fully formulated lubricant compositions. Two sets of fully formulated lubricant compositions were prepared, one set having a viscosity at 100° C. of 14 cSt, and one set having a viscosity at 100° C. of 9 cSt. The lubricant compositions were formulated as in Table 4 (weight percents are on an actives basis).

TABLE 4

| | Baseline | Treat Rate | Treat Rate |
|---|---|---|---|
| Function/Component | Formulation | (wt %) | (wt %) |
| Base oils | PAO4 4 cSt | 54 or 53.3 | 66 |
| | synthetic base oil | | |
| | PAO100 100 cSt | 36 | 24 |
| | synthetic base oil | | |
| Dispersant package | PiB succinimide | 1.18 | 1.18 |
| | dispersant | | |
| Corrosion | copper and iron | 0.24 | 0.24 |
| inhibitors | corrosion inhibitors | | |
| Extreme pressure | Sulfurized | 4.6 | 4.6 |
| package | olefin | | |
| Antifoam | Acrylate type | 0.1 | 0.1 |
| Antiwear | Preparative | To deliver | To deliver |
| agent | Example 1-7, | 900 ppm | 900 ppm |
| | Control | phosphorous | phosphorous |
| | Comparative | | |
| | Examples 1-3 | | |
| | Diluent | Balance to | Balance to |
| | Oil | 100 | 100 |
| | Viscosity at 100° C. | 14 cSt | 9 cSt |

The fluids were evaluated for wear performance in a hypoid gear durability test using a light duty hypoid gear rear drive axle using AS™ D6121 as a basis for setting up, conducting and evaluating the test. The test is a 2-stage test. The light duty hypoid gear had a ring to pin ratio of 4.45 to 1.

Stage 1 is a 65-minute break in stage run at high speed, low load to allow conditioning of the gears before the durability stage (Stage 2) is run. The wheel speed is controlled to 682 rpm and the wheel torque is controlled to 508 Nm per wheel during the conditioning phase (ring gear torque is controlled to 1016 Nm).

Stage 2 is a 24-hour durability phase to evaluate a lubricants ability to protect the gears from failure modes in accordance with AS™ D6121. The wheel speed is controlled to 124 rpm and the wheel torque is controlled to 2237 Nm per wheel (ring gear torque is controlled to 4474 Nm) during this stage.

Bulk oil temperature is measured via an immersed thermocouple and allowed to warm up unassisted to 135° C. during the conditioning phase and is maintained at 135° C. throughout the test using spray water to the outside of the axle housing. During both Stage 1 and Stage 2, the temperature of the axle oil sump is controlled with spray water. The speed and torques are smoothly ramped over several minutes (2-5) to conditioning and the test stages. Test components are removed and rated using the rating procedure outlined in AS™ D6121 by a Test Monitoring Center calibrated rater. The distress ratings and consideration of pass/fail of pinion and ring gears are assessed according to API GL-5 specifications.

The results of the tests for the 14 cSt lubricant compositions are shown in Table 5 below. All test results are at 24 hours, unless indicated otherwise.

TABLE 5
14 cSt Lubricant Compositions

| | | Ratio of | | |
|---|---|---|---|---|
| | | monohydric | | |
| | | alcohol to | Propylene | |
| Antiwear | | propylene | glycol content | Test |
| Agent | Amine | glycol | (mol %) | Result |
| Prep Ex 1 | Amine 1 | 7:1 | 12.5 | Pass |
| Prep Ex 2 | Amine 1 | 5.5:1 | 15.4 | Pass |
| Prep Ex 3 | Amine 2 | 5.5:1 | 15.4 | Pass |
| Prep Ex 4 | Amine 3 | 5.5:1 | 15.4 | Pass |
| Prep Ex 5 | Amine 3 | 5.5:1 | 15.4 | Pass |
| Prep Ex 6 | Amine 4 | 5.5:1 | 15.4 | Pass (at 36 |
| | | | | hours) |
| Comp Ex 1 | Amine 1 | N/A | 0 | Fail |
| Comp Ex 2 | Amine 3 | N/A | 0 | Fail |
| Comp Ex 3 | Amine 1 | 3.5:1 | 22.2 | Fail |

The results of the tests for the 9 cSt lubricant compositions are shown in Table 6 below.

TABLE 6
9 cSt Lubricant Compositions

| | | Ratio of | | |
|---|---|---|---|---|
| | | monohydric | | |
| | | alcohol to | Propylene | |
| Antiwear | | propylene | glycol content | Test |
| Agent | Amine | glycol | (mol %) | Result |
| Prep Ex 2 | Amine 1 | 5.5:1 | 15.4 | Pass |
| Prep Ex 7 | Amine 1 | 5.5:1 | 15.4 | Pass |
| Comp Ex 4 | Amine 1 | 7:1 (1,3diol) | 12.5 (1,3diol) | Fail |
| Comp Ex 5 | Amine 1 | 7:1 (2,3diol) | 12.1 (2,3diol) | Fail |

The results show that the materials of the present technology provide improved performance over the comparison examples when measured using the hypoid gear wear test.

Accordingly, a process for preparing a salt of a hydroxy-substituted di-ester of phosphoric acid is disclosed. The process comprises (a) reacting a phosphating agent with a monohydric alcohol and with a propylene glycol, wherein the mole ratio of monohydric alcohol : propylene glycol is greater than about 4:1, whereby the product mixture formed thereby contains phosphorus acid functionality; and (b) reacting the product mixture of step (a) with an amine comprising at least one alkyl primary amine or at least one alkyl secondary amine. The phosphating agent may comprise phosphorus pentoxide.

In some embodiments, the monohydric alcohol has about 4 to about 20 carbon atoms. In other embodiments, the monohydric alcohol comprises 2-ethylhexanol In yet other embodiments, the propylene glycol comprises 1,2-propanediol. The mole ratio of monohydric alcohol:propylene glycol can be about 8:2, or about 5.5:1 to about 7:1. In yet other embodiments, the mole ratio of monohydric alcohol:propylene glycol is about 8.4:1.6 to about 8.9:1.1.

In some embodiments, the phosphating agent comprises phosphorus pentoxide, and about 2.5 to about 3.5, or about 2.5 to about 3.0 moles of the total of monohydric alcohol plus propylene glycol are reacted per 1 mole of the phosphorus pentoxide (calculated as P₂O₅). In other embodiments, about 3.0 of the total of monohydric alcohol plus propylene glycol are reacted per 1 mole of an initial charge of phosphorus pentoxide.

The reaction of step (a) may be conducted at about 40° C. to about 110° C., or about 40° C. to about 90° C. The product mixture prepared by step (a) can be substantially free from species containing a dimeric or oligomeric moiety deriving from the dimerization or oligomerization of an alkylene oxide.

The amine may comprise at least one alkyl primary amine having about 6 to about 18 carbon atoms. In some embodiment the amine comprises at least one secondary amine having about 10 to about 22 carbon atoms.

The product prepared by the described process may be used in any industrial lubricant such as a grease, metal working fluid, industrial gear lubricant, hydraulics oil, turbine oil, circulation oil, or refrigerant.

In other embodiments, the product prepared by the described process may be added to a lubricant comprising an oil of lubricating viscosity. Methods for lubricating a driveline device such as a gear, an axle, a transaxle, or a transmission are disclosed. The methods comprise supplying the driveline device with the lubricant. In some embodiments, the gear is a hypoid gear. In other embodiments, the methods of lubricating an engine are disclosed. The methods comprise supplicating the engine with the lubricant.

The described processes may be used to prepare an antiwear agent. The antiwear agent may be used to impart antiwear performance to a lubricant composition.

Each of the documents referred to above is incorporated herein by reference. The mention of any document is not an admission that such document qualifies as prior art or constitutes the general knowledge of the skilled person in any jurisdiction. Except in the Examples, or where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the invention can be used together with ranges or amounts for any of the other elements. As used herein, the expression “consisting essentially of” permits the inclusion of substances that do not materially affect the basic and novel characteristics of the composition under consideration.

1. A process for preparing a salt of a hydroxy-substituted (di)ester of phosphoric acid, comprising:
(a) reacting a phosphating agent with a monohydric alcohol and with a propylene glycol that is 1,2-propanediol, wherein the mole ratio of monohydric alcohol: propylene glycol is about 8:2 to about 5.5:1, whereby the product mixture formed thereby contains phosphorus acid functionality; and
(b) reacting the product mixture of step (a) with an amine comprising at least one alkyl primary amine or at least one alkyl secondary amine.

2. The process of claim 1 wherein the phosphating agent comprises phosphorus pentoxide.

3. The process of claim 1 wherein the monohydric alcohol has about 4 to about 20 carbon atoms.

4. The process of claim 1 wherein the monohydric alcohol comprises 2-ethylhexanol.

5. (canceled)

6. The process of claim 1 wherein the mole ratio of monohydric alcohol:propylene glycol is about 5.5:1 to about 7:1.

7. (canceled)

8. The process of claim 1 wherein the phosphating agent comprises phosphorus pentoxide, and about 2.5 to about 3.5 moles of the total of monohydric alcohol plus propylene glycol are reacted per 1 mole of the phosphorus pentoxide (calculated as P₂O₅).

9. The process of claim 8 wherein about 3.0 of the total of monohydric alcohol plus propylene glycol are reacted per 1 mole of an initial charge of phosphorus pentoxide.

10. The process of claim 1 wherein the reaction of step (a) is conducted at about 40° C. to about 90° C.

11. The process of claim 1 wherein the product mixture prepared by step (a) is substantially free from species containing a dimeric or oligomeric moiety deriving from the dimerization or oligomerization of an alkylene oxide.

12. The process of claim 1 wherein the amine comprises at least one alkyl primary amine having about 6 to about 18 carbon atoms.

13. The process of claim 1 wherein the amine comprises at least one secondary amine having about 10 to about 22 carbon atoms.

14. The product prepared by the process of claim 1.

15. An industrial lubricant comprising the product of claim 14, wherein said industrial lubricant is a grease, metal working fluid, industrial gear lubricant, hydraulics oil, turbine oil, circulation oil, or refrigerant.

16. A lubricant comprising an oil of lubricating viscosity and the product of claim 14.

17. A method for lubricating a gear, an axle, a transaxle, or a transmission, comprising supplying thereto the lubricant of claim 16.

18. The method of claim 17, wherein the gear is a hypoid gear.

19. A method of lubricating an engine comprising supplying thereto the lubricant of claim 16.

20-21. (canceled)
